(19) United States
(12) Patent Application Publication
(10) Pub. No.: US 2002/0026836 A1
(43) Pub. Date: Mar. 7, 2002

(54) Pressure measurement cell

(75) Inventors: Frank Hegner, Lorrach (DE); Ulfert Drewes, Mullheim (DE)

Correspondence Address: Felix J. D'Ambrosio, JONES, TULLAR & COOPER, P.C., P.O. Box 2266 Eads Station, Arlington, VA, 22202, US

(73) Assignee: Endress + Hauser GmbH+ Co.

(21) Appl. No.: 09/864,173

(22) Filed: May 25, 2001

(30) Foreign Application Priority Data
Sep. 1, 2000 (DE) 100 43 630.7

(51) Int. Cl. G01L 9/00

(52) U.S. Cl. 73/717

(57) ABSTRACT

A pressure measurement cell is provided whose measurement accuracy is stable over a long time, having a first and a second base body (1, 3), and arranged between the first and the second base body (1, 3), at a distance from them, a measurement membrane (5) which has a low-pressure side on which it is connected to the first base body (1), at a first outer edge, to form a first chamber (7), and which has a high-pressure side on which it is connected to the second base body (3), at a second outer edge, to form a second chamber (9), the first edge being wider than the second edge.

The invention relates to a pressure measurement cell having a first and a second base body, and arranged between the first and the second base body, at a distance from them, a measurement membrane which has a low-pressure side on which it is connected to the first base body at a first outer edge, to form a first chamber, and which has a high-pressure side on which it is connected to the second base body at a second outer edge, to form a second chamber.

The terms low-pressure side and high-pressure side refer to the pressures normally acting on the two membrane sides during operation. That is to say, a pressure which is greater than a pressure acting on the low-pressure side normally acts on the high-pressure side during operation.

In pressure measurement technology, e.g. absolute, relative and differential pressure measurement cells are used. In absolute pressure measurement cells, a pressure to be measured is detected absolutely, i.e. as a pressure difference with respect to a vacuum. Using a relative pressure measurement cell, a pressure to be measured is detected in the form of a pressure difference with respect to a reference pressure, e.g. a pressure which prevails either measurement cell is located. In most applications, this is the atmospheric pressure at the site where it is used. In differential pressure measurement cells, the difference between a first and a second pressure is detected.

In pressure measurement technology, pressure measurement cells are described that have

a first and a second base body,

and arranged between the first and the second base body, at a distance from them, a measurement membrane

which has a low-pressure side on which it is connected to the first base body, at a first outer edge, to form a first chamber, and

which has a high-pressure side on which it is connected to the second base body, at a second outer edge, to form a second chamber.

Typically, these are metal differential pressure measurement cells, which are constructed fully symmetrically in relation to a metal measurement membrane designed as a central membrane.

In the event of pressure-dependent bending of the measurement membrane, large forces depending on the material and the geometry of the pressure measurement cell act on an inner rim of the connection between the measurement membrane and the base body in question. On the high-pressure side, the connection is tensilely loaded. Especially in the case of membranes made of a brittle material, in which the stresses that act are not distributed well, very high tensile notch stresses occur at the inner rim of the connection on the high-pressure side in the aforedescribed symmetrically constructed pressure measurement cells.

These sometimes very high tensile notch stresses entail high mechanical loading of the connection between the measurement membrane and the base body. This high mechanical loading can, in particular, lead to fatigue and premature ageing of the measurement cell and therefore, in the long term, to deterioration of the measurement accuracy or even to failure of the measurement cell.

Ceramic pressure measurement cells are advantageously used in pressure measurement technology, since ceramic pressure measurement cells have a high measurement accuracy which is stable over a very long time. One reason for this is the strong ionic bonding of ceramic, owing to which the material is very durable and substantially does not age compared with other materials, e.g. metals. Ceramic, however, is a very brittle material compared with conventional metals, and connections to the ceramic or with the ceramic are very sensitive to tensile notch stresses.

It is an object of the invention to provide a pressure measurement cell having a central membrane, whose measurement accuracy is stable over a long time.

To that end, the invention consists of a pressure measurement cell, having

a first and a second base body,

and arranged between the first and the second base body, at a distance from them, a measurement membrane

which has a low-pressure side on which it is connected to the first base body, at a first outer edge, to form a first chamber, and

which has a high-pressure side on which it is connected to the second base body, at a second outer edge, to form a second chamber,

the first edge being wider than the second edge.

According to one embodiment, the measurement membrane consists of ceramic, and it is connected to the first base body by means of a first joint and is connected to the second base body by means of a second joint.

According to a first embodiment, the first chamber is evacuated.

According to a second embodiment, a reference pressure, delivered through an opening in the first base body, prevails in the first chamber.

According to one embodiment, a pressure corresponding to a pressure to be measured, delivered through an opening in the second base body, prevails during operation in a second chamber delimited by the second base body and the measurement membrane.

According to one embodiment, the second chamber is connected to a pressure transmitter, via which a pressure corresponding to a pressure to be measured is transmitted to the second chamber during operation.

According to a third embodiment, a pressure corresponding to a first pressure, delivered through an opening in the first base body, prevails in the first chamber during operation, and a pressure corresponding to a second pressure, delivered through an opening in the second base body, prevails in the second chamber during operation.

According to one embodiment, the first chamber is connected to a pressure transmitter, via which a pressure corresponding to the first pressure is transmitted to the first chamber during operation, and the second chamber is connected to a pressure transmitter, via which a pressure corresponding to the second pressure is transmitted to the second chamber during operation.

The invention utilizes the fact that a greater pressure prevails on one side of the measurement membrane, the high-pressure side, in normal operation than on the opposite side. The measurement membrane is therefore deflected into the first chamber on the low-pressure side. Owing to the wider design of the edge on the low-pressure side, according to the invention, the measurement membrane is compressively loaded in the region of the inner rim of the edge on the low-pressure side, and bending stresses occur there. This region, however, is spatially separated from the region of the connection on the high-pressure side. Specifically, in the region of the connection on the high-pressure side, the measurement membrane bears flat on the first outer edge. Owing to this, the tensile notch stresses occurring on the high-pressure side, which strongly load the connection, are significantly reduced.

The region in which the membrane experiences the greatest bending owing to its deflection is spatially separated from the region of the connection on the high-pressure side. Even a brittle ceramic membrane is very capable of withstanding compressive notch stresses acting in this region of greatest bending.

The invention and further advantages will now be described in more detail with the aid of the figures of the drawing, in which three exemplary embodiments are represented. The same elements are provided with the same reference numbers in the figures.

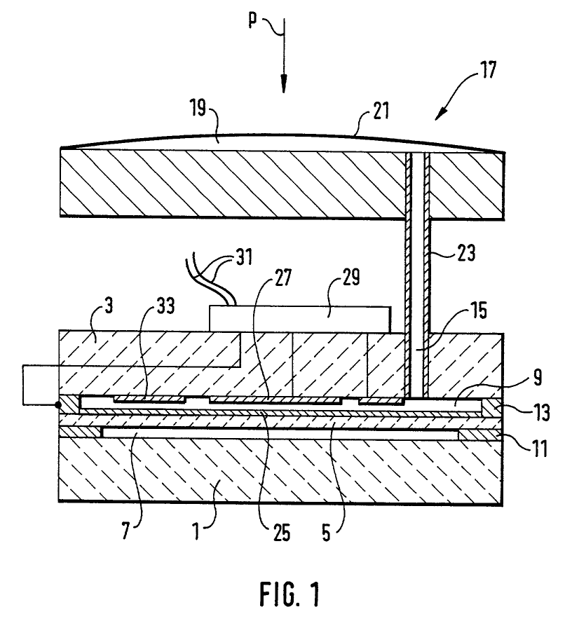

FIG. 1 shows a section through a ceramic absolute pressure measurement cell according to the invention;

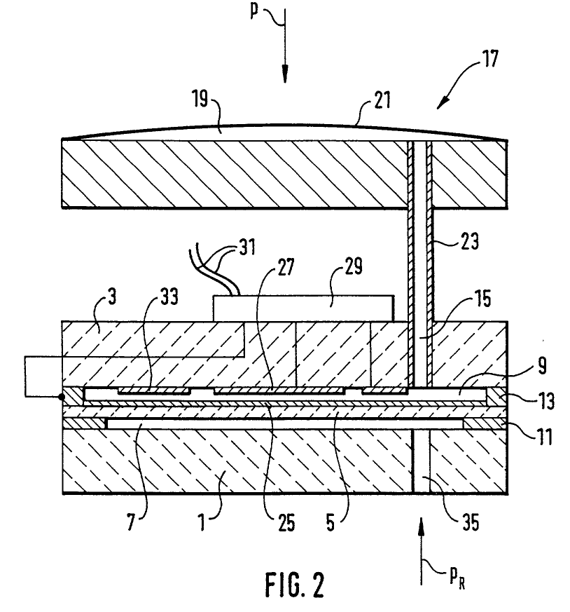

FIG. 2 shows a section through a ceramic relative pressure measurement cell according to the invention; and

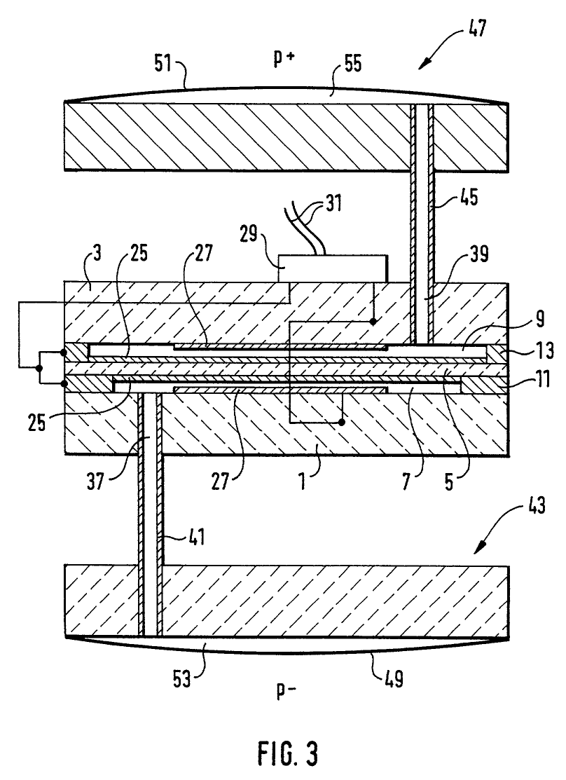

FIG. 3 shows a section through a ceramic differential pressure measurement cell according to the invention.

FIG. 1 represents a section through a pressure measurement cell according to the invention. The pressure measurement cell has a first base body 1 and a second base body 3. Between the first base body 1 and the second base body 3, a measurement membrane 5 is arranged in such a way that it is at a distance from the first and the second base body 1, 3.

The measurement membrane 5 has two sides, on each of which a pressure acts during operation. One side faces the first base body 1, and will be referred to below as the low-pressure side. The opposite side of the measurement membrane 5 faces the second base body 3, and will be referred to below as the high-pressure side. The terms low- and high-pressure side refer to the pressures normally acting on the two membrane sides during operation. That is to say, a pressure which is greater than a pressure acting on the low-pressure side normally acts on the high-pressure side during operation.

The measurement membrane 5 is connected on its low-pressure side to the first base body 1, at a first outer edge, to form a first chamber 7. On the high-pressure side, the measurement membrane 5 is connected to the second base body 3, at a second outer edge, to form a second chamber 9. The pressure measurement cell is preferably a ceramic measurement cell, i.e. the base bodies 1, 3 and the measurement membrane 5 consist of ceramic, e.g. aluminum oxide. As an alternative, the measurement membrane may also consist of sapphire. The measurement membrane 5 is connected to the first base body 1, in pressure-tight and gas-tight fashion by means of a first joint 11, at its first edge facing the first base body 1, and it is connected to the second base body 3, in pressure-tight and gas-tight fashion by means of a second joint 13, at its second edge facing the second base body 3. An example of a suitable joint material is an active hard solder. In the exemplary embodiment represented, the measurement membrane 5 is in the form of a circular disk, and the first and second base bodies 1, 3 are correspondingly cylindrical. The first and second joints 11, 13 are both annularly cylindrical. They have an outer diameter which is equal to an outer diameter of the measurement membrane 5 and of the first and second base bodies 1, 3. Owing to the joint material, the measurement membrane 5 is at a distance from the first and second base bodies 1, 3.

The first chamber 7 is hermetically sealed by the first base body 1, the measurement membrane 5 and the first joint 11, and its interior is evacuated. The second chamber 9 is delimited by the second base body 3, the second joint 13 and the measurement membrane 5. The second base body 3 has an opening 15, through which a pressure corresponding to a pressure p to be measured is delivered during operation.

In the exemplary embodiment shown, the second chamber 9 is connected to a pressure transmitter 17, via which a pressure corresponding to the pressure p to be measured is transmitted to the second chamber 9 during operation.

The pressure transmitter 17 has a liquid-filled chamber 19 which is sealed by a separation membrane 21. The chamber 19 is connected to the second chamber 9 of the pressure measurement cell via a pressure feed line 23 inserted into the opening 15. The pressure feed line 23 and the second chamber 9 are also filled with liquid. The liquid is as incompressible as possible. A suitable example is commercially available silicone oil.

During operation, the pressure p to be measured (indicated by an arrow in FIG. 1) acts on the separation membrane 21. A pressure corresponding to this pressure p is transmitted to the second chamber 9 through the liquid.

A vacuum pressure prevails in the first chamber 7, and the pressure corresponding to the pressure p to be measured prevails in the second chamber 11. The measurement membrane 5 is pressure-sensitive, i.e. a pressure acting on it causes a deflection of the measurement membrane 5 from its resting position. In the pressure measurement cell represented in FIG. 1, the deflection of the measurement membrane 5 is dependent on the pressure p to be measured, which is expressed in relation to the vacuum pressure. This is therefore an absolute pressure measurement cell.

According to the invention, the first edge, at which the low-pressure side of the measurement membrane 5 is connected to the first base body 1, is wider than the second edge, at which the high-pressure side of the measurement membrane 5 is connected to the second base body 3. In the exemplary embodiment represented in FIG. 1, the annularly cylindrical first joint 11 hence has a smaller inner diameter than the second joint 13.

During operation, a greater pressure acts on the high-pressure side of the measurement membrane 5 than on the low-pressure side. Consequently, the measurement membrane 5 experiences a deflection into the first chamber 7 during operation. Owing to the wider design of the edge on the low-pressure side, according to the invention, only a region of the measurement membrane 5 that lies inside a circle defined by the inner diameter of the first joint 11 is deflected. An outer edge of the measurement membrane 5, which is in the form of an annular disk and lies outside this circle, bears flat on the first joint 11. Although the joint 13 is therefore itself tensilely loaded slightly in the event of a very great deflection of the measurement membrane 5, tensile notch stresses that could damage or even destroy the joint 13 nevertheless do not occur. A region of the measurement membrane 5 which is in the form of an annular disk, whose outer diameter is equal to the inner diameter of the second edge and whose inner diameter is equal to the inner diameter of the first edge, receives the pressure corresponding to the pressure p to be measured. Ceramic, however, is very robust with respect to compressive loads, even with respect to notch compressive stresses, so that this pressure-loading does not have a detrimental effect. The measurement accuracy of a pressure measurement cell according to the invention is hence guaranteed over very long time periods.

The pressure measurement cell has an electromechanical transducer for detecting the deflection of the measurement membrane 5, which is dependent on the pressure p and on the vacuum pressure, and for converting it into an electrical output signal.

In the exemplary embodiment represented in FIG. 1, the electromechanical transducer comprises a first capacitor, which has a measurement electrode 25 arranged in the second chamber 9 on the measurement membrane 5, and which has a back electrode 27 arranged opposite the measurement electrode 25 on an inner wall of the second chamber 9 on the second base body 3. The capacitance of this first capacitor depends on the relative distance between the measurement electrode 25 and the back electrode 27, and is hence a measure of the deflection of the measurement membrane 5.

The measurement electrode 25 is electrically connected through the joint 13, and is e.g. grounded outside. The back electrode 27 is electrically connected through the second base body 3 to the outside of the latter, and leads to an electronic circuit 29 arranged on the second base body 3. The measurement electrode 25 and the back electrode 27 form a capacitor, and the electronic circuit 29 converts the capacitance changes of the capacitor e.g. into a correspondingly varying electrical voltage.

The output signal is available for further processing and/or evaluation via contact leads 31.

If the pressure sensor is to be used at very high temperatures, it is recommendable to arrange the electronic circuit 29 some way away from the pressure transmitter 17 and the ceramic pressure measurement cell.

It is, of course, also possible to arrange a plurality of electrodes in the second chamber 9 on the second base body 3 and/or on the measurement membrane 5. In FIG. 1, the back electrode 27 is an inner electrode in the form of a circular disk, and it is surrounded by an outer electrode 33 in the form of an annular disk. The outer electrode 33 forms, together with the measurement electrode 25, a second capacitor whose capacitance can be used for compensation purposes.

Piezoresistive elements or strain gage strips, arranged on the measurement membrane 15 in the first chamber 17, however, may also be used as electromechanical transducers.

FIG. 2 shows a section through another exemplary embodiment of a pressure measurement cell according to the invention. Owing to the great similarity with the exemplary embodiment represented in FIG. 1, only the differences will be explained in detail below. The essential difference between the two exemplary embodiments is that the first chamber 7 is not evacuated in the exemplary embodiment represented in FIG. 2. Instead, the first base body 1 has an opening 35. A reference pressure p_{R}, delivered through the opening 35 in the first base body 1, therefore prevails in the first chamber 7. This is symbolically represented by an arrow in FIG. 2.

The reference pressure p_{R} is e.g. an atmospheric pressure prevailing in the surroundings of the pressure measurement cell. The deflection of the measurement membrane 5 is therefore here dependent on the pressure p to be measured in relation to a reference pressure p_{R}. This is therefore a relative pressure measurement cell.

A great advantage of the aforedescribed pressure measurement cell, in the design as a relative pressure measurement cell, is that the electromechanical transducer is fully protected against moisture, e.g. due to condensation, and pollution. Moisture and/or pollution, as are typically contained in the atmosphere, can accumulate only in the first chamber 7. The second chamber 9, which contains electromechanical transducers that are sensitive to moisture and/or pollution, is conversely sealed from the environment.

FIG. 3, shows another exemplary embodiment of a pressure measurement cell according to the invention. Here again, because of the great similarity with the previous embodiments, only differences that exist will be explained in detail.

The pressure measurement cell represented in FIG. 3 is a differential pressure measurement cell.

A pressure corresponding to a first pressure p⁻, delivered through an opening 37 in the first base body 1, prevails in the first chamber 7, and a pressure corresponding to a second pressure p⁺, delivered through an opening 39 in the second base body 3, prevails in the second chamber 9. It is assumed here that, during normal operation, the first pressure p⁻ is less than the second pressure p⁺. Although the distinction between high-pressure and low-pressure sides represents an arbitrary definition in conventional, symmetrically constructed pressure measurement cells, at least in relation to the pressure measurement cell, and has meaning only in relation to the measurement task, this distinction is very important in pressure measurement cells according to the invention in relation to the pressure measurement cell. Owing to the asymmetric structure of the pressure measurement cell according to the invention, the pressure measurement cells according to the invention have the stated advantages only if a lower pressure than on the high-pressure side does indeed act on the low-pressure side during operation. In the converse case, a pressure measurement cell according to the invention is less robust than a symmetrically constructed pressure measurement cell.

In the pressure measurement cell represented in FIG. 3, pressure transmitters are again used to convey the first and second pressures p⁻, p⁺. The first chamber 7 is connected via a pressure feed line 41 inserted into the opening 37 to a pressure transmitter 43, via which a pressure corresponding to the first pressure p⁻ is transmitted to the first chamber 7 during operation. Similarly, the second chamber 9 is connected via a pressure feed line 45 inserted into the opening 39 to a pressure transmitter 47, via which a pressure corresponding to the second pressure p⁺ is transmitted to the second chamber 9 during operation.

The pressure transmitters 43, 47 each have a liquid-filled chamber 53, 55 sealed by a separation membrane 49, 51, and the pressure feed lines 41, 45 and the first and second chambers 7, 9 are also filled with this liquid, e.g. a silicone oil.

In principle, the measurement in the differential pressure measurement cell may take place using a single electromechanical transducer arranged in one of the chambers 7, 9. To increase the achievable measurement accuracy, however, it is recommendable to provide a capacitor, with a measurement electrode 25 arranged on the measurement membrane 5 and a back electrode 27 arranged on the respective opposite inner wall of the chamber on the first or the second base body 1, 3, in each of the first and the second measurement chambers 7, 9. It is preferable to determine the difference between the capacitances of the two capacitors, and to determine therefrom the pressure difference acting on the differential pressure measurement cell.

1. A pressure measurement cell, having
a first and a second base body (1, 3),
and arranged between the first and the second base body (1, 3), at a distance from them, a measurement membrane (5)
which has a low-pressure side on which it is connected to the first base body (1), at a first outer edge, to form a first chamber (7), and
which has a high-pressure side on which it is connected to the second base body (3), at a second outer edge, to form a second chamber (9),
the first edge being wider than the second edge.

2. The pressure measurement cell as claimed in claim 1, in which the measurement membrane (5) consists of ceramic, and it is connected to the first base body (1) by means of a first joint (11) and is connected to the second base body (3) by means of a second joint (13).

3. The pressure measurement cell as claimed in claim 1, in which the first chamber (7) is evacuated.

4. The pressure measurement cell as claimed in claim 1, in which a reference pressure (p_{R}) , delivered through an opening (35) in the first base body (1), prevails in the first chamber (7).

5. The pressure measurement cell as claimed in claim 3 or 4, in which a pressure corresponding to a pressure (p) to be measured, delivered through an opening (15) in the second base body (3), prevails during operation in a second chamber (9) delimited by the second base body (3) and the measurement membrane (5).

6. The pressure measurement cell as claimed in claim 5, in which the second chamber (9) is connected to a pressure transmitter (17), via which a pressure corresponding to a pressure (p) to be measured is transmitted to the second chamber (9) during operation.

7. The pressure measurement cell as claimed in claim 1, in which
a pressure corresponding to a first pressure (p⁻), delivered through an opening (37) in the first base body (1), prevails in the first chamber (7) during operation, and
a pressure corresponding to a second pressure (p⁺), delivered through an opening (39) in the second base body (3), prevails in the second chamber (9) during operation.

8. The pressure measurement cell as claimed in claim 7, in which
the first chamber (7) is connected to a pressure transmitter (43), via which a pressure corresponding to the first pressure (p⁻) is transmitted to the first chamber (7) during operation, and
the second chamber (9) is connected to a pressure transmitter (47), via which a pressure corresponding to the second pressure (p⁺) is transmitted to the second chamber (9) during operation.
